(19) United States
(12) Patent Application Publication
(10) Pub. No.: US 2014/0237829 A1
(43) Pub. Date: Aug. 28, 2014

(54) Adjustable Oblique Razor System

(71) Applicant: William C. Roden, Port Angeles, WA (US)

(72) Inventor: William C. Roden, Port Angeles, WA (US)

(21) Appl. No.: 14/187,763

(22) Filed: Feb. 24, 2014

Related U.S. Application Data
(60) Provisional application No. 61/770,829, filed on Feb. 28, 2013.

(51) Int. Cl. B26B 21/52; B26B 21/22

(52) U.S. Cl. CPC B26B 21/521; B26B 21/225
USPC 30/531

(57) ABSTRACT

Adjustable oblique disposable razor shaving system comprising a multi-blade cartridge configured for selective positioning of the cartridge with respect to the razor handle/head in step-wise angles of adjustability, clockwise or counterclockwise between a centered, orthogonal, Home position, to a±Left and a Right Oblique position, that ranges from about 15-20° above or below the orthogonal Home position. The selective adjustability is functionally produced by a mating button or teeth provided on the back of the cartridge, and an array of recesses or arcuate ratchet tracks in the razor head, which is mounted fixed at the usual angle to a handle. The location of the buttons and recesses can be reversed, and the cartridge may be provided with push tabs on the end edges for angle change, a trim blade, glide pad and guard sheath. A receiver is configured to assist in hands-free changing of the cartridge angle.

### CROSS-REFERENCE TO RELATED APPLICATION

This is the Regular US Application corresponding to Provisional Application Ser. No. 61/770,829 filed Feb. 28, 2013 under the same title by the same inventor, the priority of which is claimed under 35 USC §119 ff.

### FIELD

The field of this invention is disposable safety razors and more particularly to safety razors having a blade cartridge oriented with respect to the razor handle/head with a limited degree of adjustability between a centered, orthogonal, Home position, to a Left and a Right Oblique position, that ranges from about 15-20° above or below the orthogonal Home position, the adjustability being functionally produced, in one embodiment, by a mating button and array of recesses provided in the cartridge and the razor head which is mounted at the usual angle to a handle.

### BACKGROUND

Oblique shaving, a method of positioning the razor blade or blades, the latter in cartridges, at a shallow angle to the direction of motion of the shaving, is particularly effective in providing a close shave while maximizing the number of shaves per blade set before replacement blades are required.

However, to shave obliquely with a standard orthogonal razor, one in which the cartridge blades are at 90° to the axis of the razor handle, is both difficult and counter-intuitive. That is, it is difficult to hold, consistently, the razor handle at an angle (which angles the blade cartridge at a desired oblique angle) while drawing the razor in a down and up motion while contacted with the face or other body part being shaved. The natural tendency is to change the shaving motion, that is the motion of drawing the handle) orthogonal to the blade orientation, the result being an orthogonal shave. Alternatively, where the motion is down/up while the razor handle is held awkwardly at an oblique angle often results in cuts when the instinct is to follow the blade orientation. That leads to slicing the skin.

Nevertheless, a number of attempts to provide orthogonal razors in which only the blade or cartridge is angled, have been attempted over more than 80 years, each more complex than the last, and none of which have broken into the marketplace, primarily because they are too complex to manufacture and assemble, and difficult or relatively dangerous to use by the shaving consumer. None are provided as disposable because the blade angle setting mechanism is too expensive to be a throw-away razor.

Accordingly, there is a long felt but unmet need to provide a truly simple, cheap to manufacture oblique safety razor.

### THE INVENTION

The invention is directed to disposable safety razors, and more particularly safety razors having a blade cartridge configured to have limited rotation with respect to the razor handle/head for a limited degree of user oblique orientation adjustability between a centered, orthogonal, Home position, to either a Left Oblique or a Right Oblique position, that ranges from about 15-20° above or below the orthogonal Home position, the angles being defined as + or −, clockwise or counter-clockwise, respectively (See FIGS. 1-5). The adjustability is functionally produced, in a first embodiment, by mating buttons and arrays of recesses provided in the cartridge and the razor head so that the cartridge can be rotationally moved into the desired Left or Right position. The head is mounted at the usual angle to a handle via a neck. While the embodiment disclosed shows the cartridge with the buttons and the head with the recess, they may be reversed.

Instead of integral buttons molded into the cartridge back and recess arrays in the head, a second embodiment provides an arcuate groove or ratchet (See FIG. 6), for example disposed in the head, and a pair of aligned buttons or teeth in the cartridge. This multi-tooth ratchet and groove system permits multi-position oblique angle spacing, for example at 3-5° increments. In still another alternative, a spring detent system may be employed.

The disposable razors of the invention include both entirely disposable razors including head, cartridge and handle, and partially disposable types in which only the cartridge and head may be released from the razor handle neck portion for disposal.

A standard multi-blade safety razor cartridge may be employed, the back face of which is provided with spaced buttons or teeth (see FIGS. 7-9) that are located to align with either the recesses or the ratchet (groove) arc. The recesses are also arrayed in arcs. The back of the cartridge portion also includes a post or stud of length long enough to go through, or into, a bore in the head of the razor. After insertion of the cartridge post in the bore of the razor head, the post is heat-formed in a mushroom to provide sufficient frictional resistance to prevent rotating while shaving, but permitting rotation by the user by pushing down one end of the cartridge to cause the buttons to pop out of one recess pair and into another.

In another alternative the post is provided with an enlarged ring around the post that snap fits in a mating groove in the bore.

In another option, a reverse-oriented trim blade may be provided, in which case a small push tab is provided on each end of the cartridge that is pushed down to rotate the cartridge with respect to the razor head. That keeps the fingers free from the exposed trim blade along the top edge. The cartridge should be rotated back to the Home position to employ the trim blade. In another alternative, a disk-shaped “puck” having a recess to receive the cartridge is provided. The user places the cartridge in the recess and rotates the razor handle left or right to change the oblique angle of the cartridge with respect to the razor head. The sides of the puck may be provided with grooves to assist in gripping with the other hand. This puck device permits quick, safe, hands-free change of oblique angle of the cartridge with respect to the head.

The two oppositely oblique angles, Left and Right, are provided for left and right handed users, and for shaving left and right sides of the face or other body part, thereby making this design universal.

### BRIEF DESCRIPTION OF DRAWINGS

The inventive adjustable oblique razor system is illustrated in the accompanying drawings, in which:

FIG. 1 includes two views, on the left is a front view of a multi-blade cartridge, and on the right is a top view showing positioning buttons and a centrally mounted post;

FIG. 2 is a front or face view of a razor head with two arcuate arrays of shallow holes, one on the left (top in this view), and one on the right (bottom in this view), and a central hole to receive the cartridge post;

FIG. 3 is a top view of the inventive cartridge of FIG. 1 assembled in the razor head of FIG. 2, taken along the line 3-3 in FIG. 2, showing the cartridge positioning buttons seated in suitable holes of the razor head arrays; in this embodiment, the cartridge post passes through the razor head and terminates in a securing mushroom shape to retain the cartridge on the razor head with suitable frictional resistance against free-rotation;

FIG. 4 is a front view of the inventive cartridge inserted in the razor head so that it is oriented with respect to the head in a standard orthogonal, Home position;

FIG. 5 is a front view of the inventive cartridge oriented in a Right oblique position (right end of the cartridge from 15-20° above the orthogonal, Home position);

FIG. 6 is a front view of another embodiment of the razor head employing arcuate ratchet grooves for step-wise, discrete angular positioning of the cartridge with respect to the razor head;

FIG. 7 is a back view of a second embodiment of the cartridge of that may be used with the razor head of FIG. 6; in this embodiment the buttons are replaced by angled ratchet teeth;

FIG. 8A is a top view of the second embodiment of a cartridge of FIG. 7, having angled teeth that engage the ratchet grooves of FIG. 6, and push tabs being shown knurled or ribbed to assist in good, non-slip grip for rotating the cartridge with respect to the razor head;

FIG. 8B is a section view taken along the line 8B-8B of FIG. 8A showing one shape of the teeth;

FIG. 9 is an end view of a cartridge of FIGS. 1, 3-5, 7 and 8, showing the reverse angle orientation of a trim blade a pad and guard feature; and

FIG. 10 is an isometric view of a puck device having a cartridge-receiving recess to permit changing the angle of the cartridge with respect to the razor head.

### DETAILED DESCRIPTION WITH REFERENCE TO THE FIGURES

The following detailed description illustrates the invention by way of example, not by way of limitation of the scope, equivalents or principles of the invention. This description will clearly enable one skilled in the art to make and use the invention, and describes several embodiments, adaptations, variations, alternatives and uses of the invention, including what is presently believed to be the best modes of carrying out the invention.

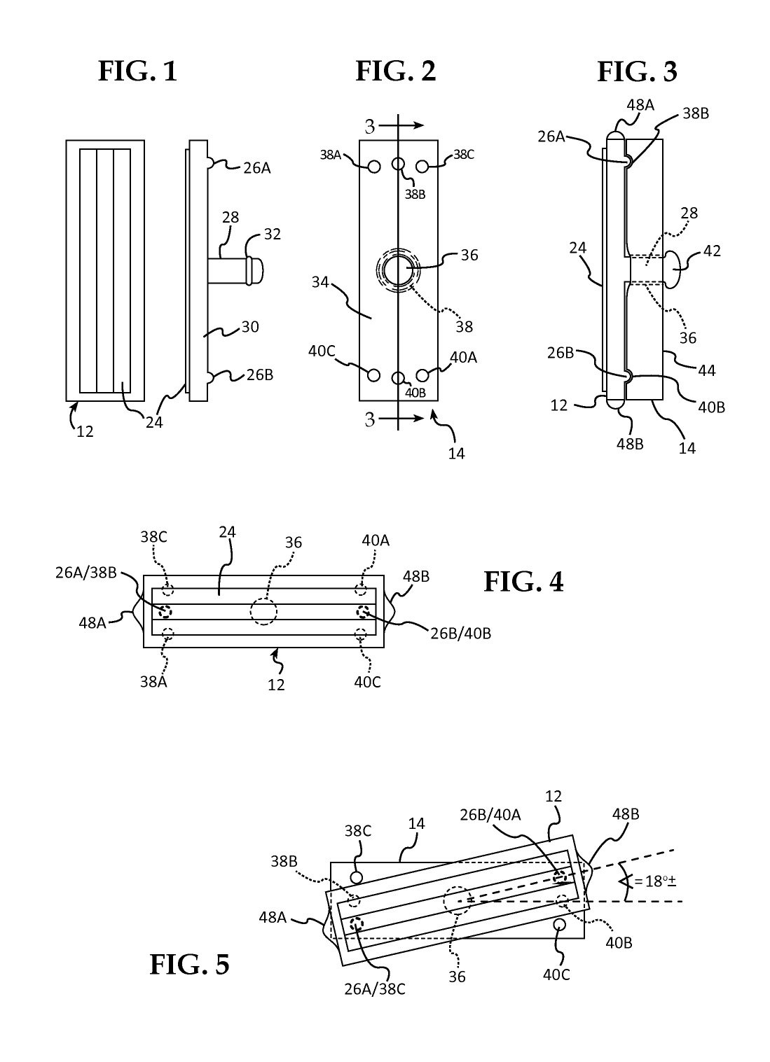

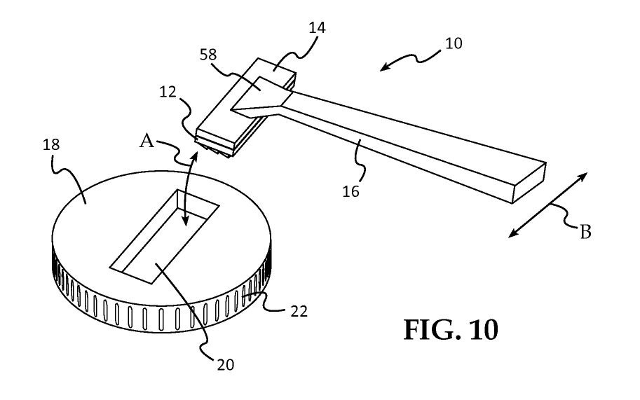

FIG. 1, on the left, shows a front view of an exemplary multi-blade disposable cartridge 12 of the inventive adjustable oblique razor system 10 (best seen in FIGS. 9 and 10). The cartridge contains one or more conventional shaving blades 24 secured in the cartridge in an appropriate projecting angle shaving array. The top view of FIG. 1, on the right, shows buttons 26A, 26B laterally spaced from a central pivot post 28 formed in the back face 30 of the cartridge 12. In this embodiment, the post 28 may be short enough to not pass completely through the razor head 14 (see FIG. 2), and may be designed with a slight enlargement 32 to press-fit into a groove 38 in the bore 36 of the razor head 14.

FIG. 2 is a front or face view of a razor head having two, spaced arcuate arrays of shallow holes or recesses 38A, B, C on the left (top in this view), and 40A, B, C on the right (bottom in this view) in the face 34 of the razor head 14. A central bore 36 is provided to receive the pivot post 28 of the cartridge 12. In this embodiment, coordinate with the post enlargement 32, a press-fit groove 38 is provided. The recesses or holes 38A-C and 40A-C are arrayed in an arc so that each recess of each array, left (top) and right (bottom) are equidistant. The recesses 38B, 40B receive the buttons 26A, 26B, respectively for the Home (orthogonal or standard) orientation of the cartridge 12 with respect to the head 14. For oblique angles, the recesses 38A, 40A receive the cartridge buttons for a first, counterclockwise angle (see FIG. 5), called a negative angle. Recesses 38C, 40C receive the cartridge buttons for a second, clockwise angle, called a positive angle. The spacing of the recesses are selected to be in the range of from about 5°-20° apart, and are fixed at the selected angles formed by the seating of the buttons in the recesses. It has been found that a particularly suitable angle for a very close shave is 18±° (see FIG. 5). Where the angle of the cartridge 12 is aligned with the head 14, the angle is 0°, and this is called the Home position.

FIG. 3 is a top view of the inventive cartridge 12 of FIG. 1 assembled in the razor head 14 of FIG. 2, with the buttons 26A, 26B seated in suitable recesses of the array, here shown as recesses 38B and 40B, respectively, the Home or orthogonal position. FIG. 3 also shows a second embodiment of the post 28 in which the post passes through the razor head borehole 36, and is heat or pressure-formed into a mushroom shape 42 to retain the cartridge 12 on the razor head 14 with the required amount of friction to prevent free swiveling. The buttons must engage their respective recesses to retain the desired orientation, and it is preferred for them to snap-into the respective recesses to retain the selected negative or positive angular orientation. The mushroom head 42 may also be a separate piece that is solvent or heat glued, or snaps onto the end of the post projecting form the back side or back face 44 of the head 14. The mushroom head may also be recessed into the back face 44 of the head 14.

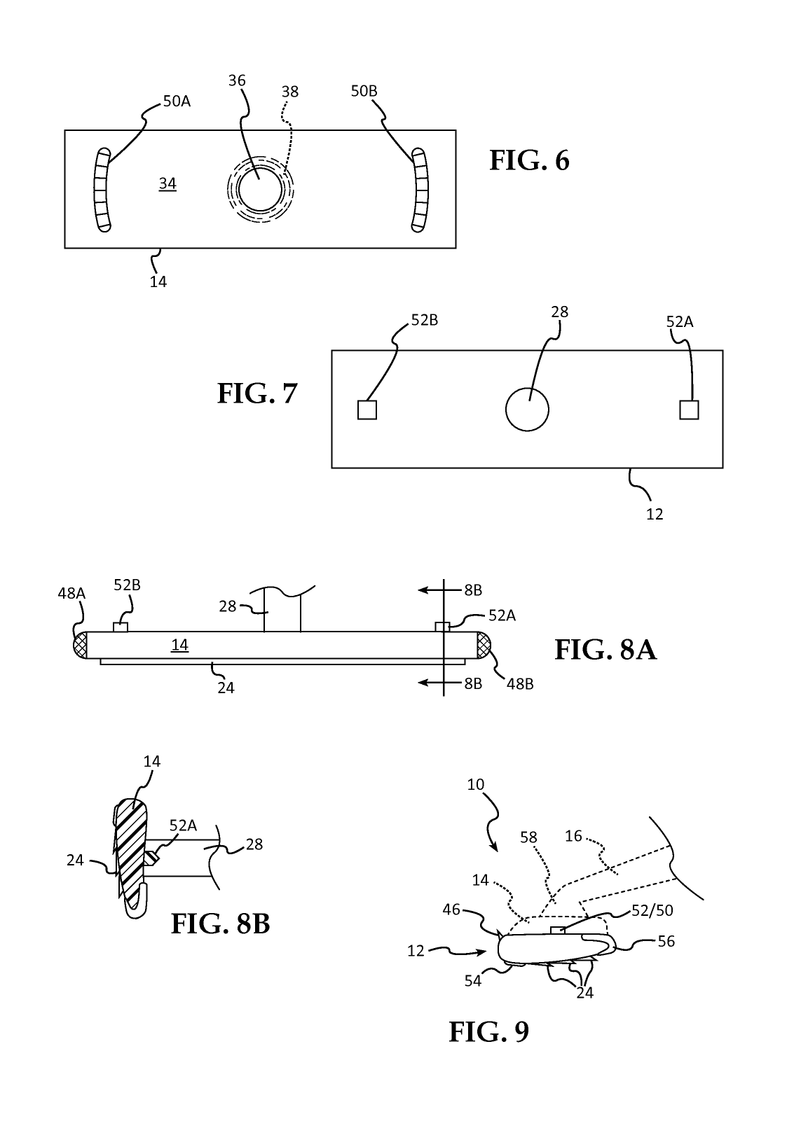

The snap fit of the rotating pivot post 28 in the borehole 36 is configured, including the length dimension, to insure that there is a snug, snap fit of the buttons (or teeth 52 of FIGS. 6-9) in their respective recesses (or the grooves 50 in FIGS. 6-9) so that the cartridge does not freely rotate. That is, it requires some torque to rotate the cartridge with respect to the head, so that during shaving the selected oblique angle is fixed.

FIG. 4 is a front view of the inventive cartridge 14 oriented with respect to the head in a standard orthogonal, 0°, Home position. This standard position is useful for shaving square to sideburn ends, under the nose, or the front of the neck, as need be. As described above with respect to FIG. 3, in the Home orientation, the button 26A on the left is received in recess 38B on the left, and button 26B is received in recess 40B, both on the right. This figure shows the orientation for use of the exposed trim blade 46 (FIG. 9), and the side push tabs 48A, 48B to assist in rotating the cartridge among the several positions ±.

FIG. 5 is a front view of the inventive cartridge 14 oriented in a counterclockwise, or negative, (Right) oblique position (right end of the cartridge from 15-30° above the orthogonal, Home position), in which button 26A on the left is received in recess 38C on the left, and button 26B on the right is received in recess 40A on the right. From the Home position, the Right, or negative oblique position is achieved by pushing down on the left side push tab 48A, and/or push up on the right side push tab 48B. To reverse the oblique angle, the upper right of the cartridge 14 is pushed down by manipulating the right side push tab 48B so that button 26A is received in recess 38C, and button 26B is received in recess 40C for a negative 15-30° oblique angle, below the Home position.

FIG. 6 is a front view of the head 14, showing another embodiment of the step-wise orthogonal angle selecting system employing ratchets or teeth 52A, B (FIG. 7) and an arcuate array of grooves 50A and 50B.

FIG. 7 is a back view of the corresponding cartridge 12 having V-shaped or slanted teeth 52A, 52B in place of buttons 26A, 26B of the embodiment of FIGS. 1, 3-5, 8 and 9. FIGS. 8A and 8B show details of the teeth, in which FIG. 8A is a top view of a cartridge having angled ratchets or teeth that engage the grooves of FIG. 6, the top of the push tabs being shown knurled or ribbed to assist in good, non-slip grip. FIG. 8B is a section view taken along line 8B-8B of FIG. 8A, showing that the teeth, in this embodiment are configured with a V-shaped tip to engage the grooves in the arcuate arrays 50A, 50b of FIG. 6.

FIG. 9 is an end view of a cartridge of FIGS. 1, 3-5, 7 and 8B as assembled on a head 14 and handle 16 having an inclined neck portion 58, showing the reverse angle orientation of the trim blade 46. In addition a standard glide strip pad 54 and guard 56 may be provided.

FIG. 10 is an isometric view of the entire inventive adjustable oblique shaving system as including a hands-free receiver 18, in this embodiment a disc or puck device having grip-assisting edge ribs or knurling 22, to assist in changing the angle of the cartridge 12 with respect to the razor head 14. This is done by insertion of the cartridge 12 into a recess 20 in the disk-shaped puck 18, and rotating the handle of the razor 16 to the left or right to change the angle of the cartridge to the desired right or left, ±, oblique angle, or back to the Home, 0° position, as desired. The Home position may be selected to use the trim blade on side-burns, under the nose, the horizontal chin groove, around the lips, etc. The receiver 18 is a safety system, as it does not expose fingers to the trim blade 46 (see FIG. 9) or shaving blades 24.

From a study of the figures, it will be self-evident to one of ordinary skill in the art that the several features of the invention and manner in which they cooperate to produce the inventive universal and adjustable, oblique safety razor system are easily understood. In actual use, orienting the shaving cartridge in an oblique position, ±, provides a much improved shave as the blades slice the beard or hair at a diagonal while the razor handle is pulled down or up in the usual orthogonal stroke, that is 90° to the line of the jaw. The result is a very clean, smooth shave with less irritation. The adjustability from + to − oblique angles permits the inventive system to be used by both left and right-handed people, and to adjust the angle from + to − oblique orientation, or the reverse, for different sides of the face, arms, legs, etc.

It should be understood that various modifications within the scope of this invention can be made by one of ordinary skill in the art without departing from the spirit thereof and without undue experimentation. For example, the buttons, recesses, ratchets, grooves and pivot post can have a wide range of designs to provide the functionalities disclosed herein. As an example, the post may be a rod of 20-40 sides that fits into a corresponding multi-sided bore, so that torquing the cartridge rotates the rod stepwise in the bore. A 20-sided rod results in 18° orthogonal increments. The bore may include a stop to prevent the angle from exceeding a selected angular limit, on the order of 30-40°±. Another design would be to fit the post with a spring loaded detent that engages recesses spaced along the inner circumference of the bore in the preselected oblique angular positions. Likewise, the push tabs may be located on the top edge or elsewhere on the cartridge, rather than the exemplary side edge shown in FIGS. 3-5. In a converse alternative, the buttons/teeth may be formed in the razor head with the recesses/groove tracks located in the back of the cartridge. The mushroom head 42 may be formed as a push-button release to remove the cartridge from the head in replaceable cartridge embodiments. The razor head may be orthogonally pivotably secured to the handle, so that the head moves up or down to follow the contours of the skin during shaving; such pivots are well known in the art. In addition, while the embodiments shown herein use a pivot post fitted in a borehole, it should be understood that there are a number of other alternative ways in which the blade cartridge may be rotatably secured to said razor head; for example, the post may be in the razor head with the borehole in the cartridge.

While a principal embodiment of the invention is for an entire disposable razor system, that is, handle plus head and cartridge, it is within the scope of the invention to provide a configuration by which only the head and cartridge assembly may be removed for disposal from the neck portion of the handle. One example of such a disposable cartridge/head configuration is reciprocating hooks or teeth in the neck that are actuated by a push button, the teeth gripping the head via slots in it. The receiver disk 18 may include indicia on its top surface indicating the angles to rotate the razor handle to effect the incremental oblique angle adjustments.

By way of geometric definitions, the razor head is generally rectangular and has a generally planar face. The razor head is secured to the razor handle at an inclined angle, the handle having a central axis along its length. The razor head has a lateral long axis and a vertical short axis when viewed face on, and the razor head is secured to the handle with its long lateral axis orthogonal to the central axis of the razor handle. As described herein by way of example in the several alternative designs, the razor head is configured to receive and retain a generally rectangular blade cartridge which has a generally planar back and a long lateral axis, and at least one razor blade that is non-removably fixed at a shaving angle in it. The blade cartridge is configured to be rotatably secured to the razor head in a plurality of shaving positions selected from orthogonal to oblique. The blade cartridge and razor head are co-operatingly configured to provide pre-selected limited oblique angular adjustment of the blade cartridge with respect to the razor head around a central axis of the cartridge. The cartridge central axis is defined generally normal to the planar back of the cartridge and to the planar face of the razor head. The oblique angular adjustment of the cartridge is limited to a range of ±15°-40° in a plurality of discrete increments, with the positive oblique angle being defined as clockwise with respect to an orthogonal Home position in which the axes of the cartridge and the head are parallel, at 0° to each other, and the negative oblique angle being defined as counterclockwise with respect to the orthogonal Home position.

This invention is therefore to be defined by the scope of the appended claims as broadly as the prior art will permit, and in view of the specification if need be, including a full range of current and future equivalents.

### INDUSTRIAL APPLICABILITY

The inventive system, being easily manufactured, is particularly useful for disposable razors, providing a high quality of shave not ordinarily possible for cheap disposables. Thus, the inventive razor system has the clear potential of becoming adopted as the new standard for disposable shaving systems, both entire razors or disposable cartridges only.

Parts List (This Parts List is provided as an aid
to Examination and may be canceled upon allowance)

```
  10 Inventive adjustable oblique razor system
  12 Multi-blade cartridge
  14 Head
  16 Handle
  18 Receiving means to adjusting cartridge angle; e.g. a puck
  20 Recess for cartridge
  22 Ribs or grooves for grasping
  24 Array of shaving blades
  26 A, B buttons
  28 Pivot post
  30 Back face of cartridge
  32 Post enlargement
  34 Front face of razor head
  36 Hole for pivot post in Head 14
  38 Groove in Head hole 36
  38 A-C Recesses for 26A
  40 A-C Recesses for 26B
  42 Mushroom
  44 Back face of head
  46 Trim blade
  48 A, B Push tab
  50 A, B Ratchet groove array
  52 A, B Ratchet teeth
  54 Glide Pad (strip)
  56 Guard
  58 Inclined Neck
  60
  62
  64
  66
  68
  70
  72
  74
  76
  78
  80
  82
  84
  86
  88
  90
  92
  94
  96
  98
100
102
104
106
108
110
112
114
118
120
122
124
126
128
130
132
134
136
138
140
142
144
146
148
```

1. An adjustable oblique safety razor system comprising in operative combination:
a) a razor handle having secured thereto at an inclined angle a generally rectangular razor head, said handle having a central axis along its length;
b) said razor head having a generally planar face, a lateral long axis and a vertical short axis when viewed face on, said razor head being secured with its long lateral axis orthogonal to said central axis of said razor handle;
c) said razor head is configured to receive and retain a blade cartridge;
d) a generally rectangular blade cartridge having a generally planar back and a long lateral axis;
e) said blade cartridge having at least one razor blade that is non-removably fixed at a shaving angle therein, said blade cartridge is configured to be rotatably secured to said razor head in a plurality of shaving positions selected from orthogonal to oblique;
f) said blade cartridge and razor head being co-operatingly configured to provide pre-selected limited oblique angular adjustment of said blade cartridge with respect to said razor head around a central axis of said cartridge defined generally normal to said planar back of said cartridge and to said planar face of said razor head; and
g) said oblique angular adjustment being limited to a range of ±15°-40° in a plurality of discrete increments, said positive oblique angle being defined as clockwise with respect to an orthogonal Home position in which said axes of said cartridge and said head are parallel at 0° to each other, and said negative oblique angle being defined as counterclockwise with respect to said orthogonal Home position.

2. An adjustable oblique safety razor system as in claim 1, wherein said blade cartridge and said razor head co-operative configuration is selected from a) a pair of raised buttons that may be selectively received in coordinate pairs of recesses arrayed in an arc around said cartridge central axis, and b) from teeth that engage groves arrayed in an arc around said cartridge central axis, said recesses and grooves in each array being spaced apart along said arc to provide said discrete increments of oblique angle.

3. An adjustable oblique safety razor system as in claim 2 wherein said buttons or teeth are configured on the back surface of said cartridge, and said recesses or grooves are arrayed on the face of said razor head.

4. An adjustable oblique safety razor system as in claim 1 wherein said cartridge is configured with a pivot post that is received in a borehole in said razor head to provide an axis for said oblique angular rotation, said pivot post being configured to maintain said cartridge in a non-freely rotating retaining engagement with said razor head, so that said blades remain fixed in a selected oblique angle during shaving.

5. An adjustable oblique safety razor system as in claim 2 wherein said cartridge is configured with a pivot post that is received in a bore in said razor head to provide an axis for said oblique angular rotation, said pivot post being configured to maintain said cartridge in a non-freely-rotating, retaining engagement with said razor head, so that said blades remain fixed in a selected oblique angle during shaving.

6. An adjustable oblique safety razor system as in claim 4 wherein said pivot post is configured to snap fit into said bore in said razor head.

7. An adjustable oblique safety razor system as in claim 5 wherein said pivot post is configured to snap fit into said bore in said razor head.

8. An adjustable oblique safety razor system as in claim 1 wherein said razor, including handle, head and cartridge are disposable.

9. An adjustable oblique safety razor system as in claim 1 wherein said razor handle includes an inclined neck portion, said razor head and cartridge assembly is disposable, and said razor head and cartridge assembly said neck portion are configured for said razor head and cartridge assembly to be removably securable to said neck portion.

10. An adjustable oblique safety razor system as in claim 1 which includes a receiver assembly having a recess configured with a depth permitting releasably receiving said cartridge but not said razor head so that upon rotating said razor handle, said cartridge may be rotated from a first angle to a second, at least one of said angles being an oblique angle.

11. An adjustable oblique safety razor system as in claim 5 which includes a receiver assembly having a recess configured with a depth permitting releasably receiving said cartridge but not said razor head so that upon rotating said razor handle, said cartridge may be rotated from a first angle to a second, at least one of said angles being an oblique angle.

12. An adjustable oblique safety razor system as in claim 10 wherein said receiver is generally disk shaped, and the outside periphery of said disk is configured to improve hand grip.

13. An adjustable oblique safety razor system as in claim 11 wherein said receiver is generally disk shaped, and the outside periphery of said disk is configured to improve hand grip.

14. An oblique safety razor system as in claim 3 wherein said cartridge and said head are configured to provide at least three positions selected from a Home orthogonal position, a first negative position and a second positive position.

15. An oblique safety razor system as in claim 11 wherein said cartridge and said head are configured to provide at least three positions selected from a Home orthogonal position, a first negative position and a second positive position.

16. An oblique safety razor system as in claim 1 wherein said cartridge includes push tabs configured on oppose edges of said cartridge to assist in rotating said cartridge by hand to a selected orthogonal or oblique position.

17. An oblique safety razor system as in claim 2 wherein said cartridge includes push tabs configured on oppose edges of said cartridge to assist in rotating said cartridge by hand to a selected orthogonal or oblique position.

18. An oblique safety razor system as in claim 4 wherein said post and bore configuration includes a spring-loaded detent and a plurality of recesses to receive said detent in said preselected oblique angular positions.

19. An oblique safety razor system as in claim 4 wherein said post comprises a rod having a plurality of flat sides along a portion of its length, and said bore is congruently configured with a plurality of flat sides matching said rod sides, said rod and bore being configured to cooperate so that upon rotating said cartridge to align a rod flat side with a bore flat side said cartridge is retained for shaving at one of said preselected oblique angular positions.

20. An oblique safety razor system as in claim 18 wherein said cartridge includes push tabs configured on oppose edges of said cartridge to assist in rotating said cartridge by hand to a selected orthogonal or oblique position.
